(19) United States
(12) Patent Application Publication
(10) Pub. No.: US 2025/0258826 A1
(43) Pub. Date: Aug. 14, 2025

(54) EFFICIENT LOOK-UP FOR VECTOR SYMBOLIC ARCHITECTURES (VSA)

(71) Applicant: International Business Machines Corporation, Armonk, NY (US)

(72) Inventors: Tayfun Gokmen, Briarcliff Manor, NY (US); Vasileios Kalantzis, Nyack, NY (US); Parikshit Ram, Atlanta, GA (US); Chai Wah Wu, Hopewell Junction, NY (US); Kenneth Lee Clarkson, Madison, NJ (US); Lior Horesh, North Salem, NY (US); Shashanka Ubaru, Ossining, NY (US)

(21) Appl. No.: 18/436,481

(22) Filed: Feb. 8, 2024

(51) Int. Cl. G06F 16/2455; G06F 16/22

(52) U.S. Cl. CPC G06F 16/24561; G06F 16/2237; G06F 16/2264

(57) ABSTRACT

A method for hyperdimensional computing to obtain an answer to a query includes encoding each of an N number of data points related to the query with a first high dimensional vector P and a second high dimensional vector H to generate an encoded N number of data points having a P vector component and an H vector component, processing the encoded N number of data points via a first sub-routine to generate an intermediate result, wherein the first sub-routine is responsive to Vector Symbolic Architecture (VSA) operations, processing the intermediate result via a second sub-routine to generate a final result, wherein the second sub-routine is responsive to Vector Symbolic Architecture (VSA) operations and conducting a similarity search of the P vector component of the final result to generate an answer to the query.

### BACKGROUND

The present invention generally relates to a method for searching data on a computer framework, and more particularly to a system and method for efficiently searching data represented as hyperdimensional vectors on a computer framework.

Hyperdimensional computing (HDC) is a biologically inspired framework which represents symbols with high-dimensional vectors, and which uses vector operations to manipulate the high-dimensional vectors. The ensemble of a particular vector space and a prescribed set of vector operations (including one addition-like for “bundling” and one outer-product-like for “binding”) form a Vector Symbolic Architecture (VSA). VSAs are robust to noise and the fact that all entries of the vectors are symmetric (i.e., they don't correspond to specific features) allows VSA computations to be highly parallelizable. And because most VSA vector entries are either 0 or ±1, there is no need for floating point arithmetic, thereby allowing for energy-efficient and low-latency hardware implementations.

Unfortunately, however, the sheer size of the data and the vector space, along with the “curse of dimensionality” cause various challenges with efficiency and other complications to arise when searching, analyzing, and organizing data in the high-dimensional spaces of VSAs. For example, one such issue involves similarity searches which are a common problem in data science applications. In this instance, searches are conducted to identify similar documents out of a repository of billions of documents. A brute force approach in this case typically never works due to pure scaling. And although several techniques have been proposed to speed up similarity searches, such as locality sensitive hashing and product quantization, these techniques are still efficient and typically cannot be directly applied to VSAs.

### SUMMARY

A method for hyperdimensional computing to obtain an answer to a query is provided, where the method includes encoding each of an N number of data points with a first high dimensional vector P and a second high dimensional vector H to generate an encoded N number of data points having a P vector component and an H vector component, processing the encoded N number of data points via a first sub-routine to generate an intermediate result (P,H)ᵢₙₜ, wherein the first sub-routine is responsive to Vector Symbolic Architecture (VSA) operations, processing the intermediate result (P,H)ᵢₙₜ via a second sub-routine to generate a final result (P,H)ᵣₑₛᵤₗₜ, wherein the second sub-routine is responsive to Vector Symbolic Architecture (VSA) operations and conducting a similarity search of the P vector component of the final result (P,H)ᵣₑₛᵤₗₜ to generate an answer to the query.

Embodiments of the invention are also directed to computer-implemented methods and computer program products having substantially the same features and functionality as the computer system described above.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 illustrates information being represented as hyperdimensional vectors having thousands of dimensions and common Vector Symbolic Architecture (VSA) operations, in accordance with the prior art.

FIG. 2 illustrates two different types of data structures used with VSAs.

FIG. 3 illustrates a conventional encoding scheme used with VSAs, in accordance with the prior art.

FIG. 4 illustrates an encoding scheme for use with VSA, in accordance with one or more embodiments of the invention.

FIG. 5 illustrates HD Computing operations for use with VSAs.

FIG. 6 is an operational block diagram illustrating a method for Hyperdimensional (HD) computing to obtain an answer to a query, in accordance with one or more embodiments of the invention; and

FIG. 7 shows a block diagram of an example computer system for use in accordance with one or more embodiments of the invention.

### DETAILED DESCRIPTION

In one embodiment of the invention, a method for hyperdimensional computing to obtain an answer to a query, includes encoding each of an N number of data points related to the query with a first high dimensional vector P and a second high dimensional vector H to generate an encoded N number of data points having a P vector component and an H vector component. The encoded N number of data points are processed via a first sub-routine to generate an intermediate result, where the first sub-routine is responsive to Vector Symbolic Architecture (VSA) operations. The intermediate result is processed via a second sub-routine to generate a final result, wherein the second sub-routine is responsive to Vector Symbolic Architecture (VSA) operations. A similarity search of the P vector component of the final result is conducted to generate an answer to the query. The method advantageously allows for a more efficient similarity search to be conducted of only the P vector components of the final result to generate an answer to the query without having to conduct a search of the much larger dimension H vector components.

In some examples of the method, the N number of data points are selected responsive to the query.

In further examples of the method, the H vector component is larger than the P vector component.

In yet further examples of the method, the first sub-routine includes performing a bundling/superposition operation on the P vector component and the H vector component to generate an N number of bundled data points within the P vector component and the H vector component together.

In yet further examples of the method, the first sub-routine includes performing a binding operation on the N number of bundled data points to generate the intermediate result having an N number of bound data points within the P vector component and the H vector component.

In yet further examples of the method, the second sub-routine includes performing a unbinding operation on the N number of bound data points to generate an N number of unbound data points within the P vector component and the H vector component.

In yet further examples of the method, the second sub-routine includes performing a permutation operation on the N number of unbound data points to generate the final result having an N number of permutated data points within the P vector component and the H vector component.

In another aspect of the invention, a computing system includes a machine learning system to implement a method for hyperdimensional computing to obtain an answer to a query, where the method includes encoding each of an N number of data points related to the query with a first high dimensional vector P and a second high dimensional vector H to generate an encoded N number of data points having a P vector component and an H vector component. The encoded N number of data points are processed via a first sub-routine to generate an intermediate result, where the first sub-routine is responsive to Vector Symbolic Architecture (VSA) operations. The intermediate result is processed via a second sub-routine to generate a final result, where the second sub-routine is responsive to Vector Symbolic Architecture (VSA) operations. The computing system conducts a similarity search of the P vector component of the final result to generate an answer to the query. The computing system provides a physical system for implementing a method which advantageously allows for a more efficient similarity search to be conducted of only the P vector components of the final result to generate an answer to the query without having to conduct a search of the much larger dimension H vector components.

In some examples of the computing system, the N number of data points are selected responsive to the query.

In further examples of the computing system, the H vector component is larger than the P vector component.

In yet further examples of the computing system, the first sub-routine includes performing a bundling/superposition operation on the P vector component and the H vector component to generate an N number of bundled data points within the P vector component and the H vector component together.

In yet further examples of the computing system, the first sub-routine includes performing a binding operation on the N number of bundled data points to generate the intermediate result having an N number of bound data points within the P vector component and the H vector component.

In yet further examples of the computing system, the second sub-routine includes performing a unbinding operation on the N number of bound data points to generate an N number of unbound data points within the P vector component and the H vector component.

In yet further examples of the computing system, the second sub-routine further includes performing a permutation operation on the N number of unbound data points to generate the final result having an N number of permutated data points within the P vector component and the H vector component.

Yet another aspect of the invention includes a computer program product having a computer readable storage medium. The computer readable storage medium stores program instructions which are executable by a processor to cause the processor to perform operations for implementing a method for hyperdimensional computing to obtain an answer to a query. The method includes the steps of encoding each of an N number of data points related to the query with a first high dimensional vector P and a second high dimensional vector H to generate an encoded N number of data points having a P vector component and an H vector component. The encoded N number of data points are processed via a first sub-routine to generate an intermediate result, where the first sub-routine is responsive to Vector Symbolic Architecture (VSA) operations. The intermediate result is processed via a second sub-routine to generate a final result, where the second sub-routine is responsive to Vector Symbolic Architecture (VSA) operations. The method further includes conducting a similarity search of the P vector component of the final result to generate an answer to the query. The computer program product provides a physical means for distributing, and installing on a computer system, the method advantageously allows for a more efficient similarity search to be conducted of only the P vector components of the final result to generate an answer to the query without having to conduct a search of the much larger dimension H vector components.

In some examples of the computer program product, the N number of data points are selected responsive to the query, and the H vector component is larger than the P vector component.

In further examples of the computer program product, the first sub-routine includes performing a bundling/superposition operation on the P vector component and the H vector component to generate an N number of bundled data points within the P vector component and the H vector component together.

In yet further examples of the computer program product, the first sub-routine includes performing a binding operation on the N number of bundled data points to generate the intermediate result having an N number of bound data points within the P vector component and the H vector component.

In yet further examples of the computer program product, the second sub-routine includes performing a unbinding operation on the N number of bound data points to generate an N number of unbound data points within the P vector component and the H vector component.

In yet further examples of the computer program product, the second sub-routine includes performing a permutation operation on the N number of unbound data points to generate the final result having an N number of permutated data points within the P vector component and the H vector component.

As discussed briefly above, the present invention relates to a method for efficiently searching data represented as hyperdimensional vectors on a computer framework. The method provides a unique and more efficient approach for conducting similarity searches in Vector Symbolic Architectures (VSAs) which supports the VSA operations (e.g., bunding, binding, unbinding, permutation) needed to run the VSA algorithms. Common properties of VSAs include brain inspired computing where the computing elements can be stochastic. This allows for a high degree of parallelism having a distributed representation with error correcting.

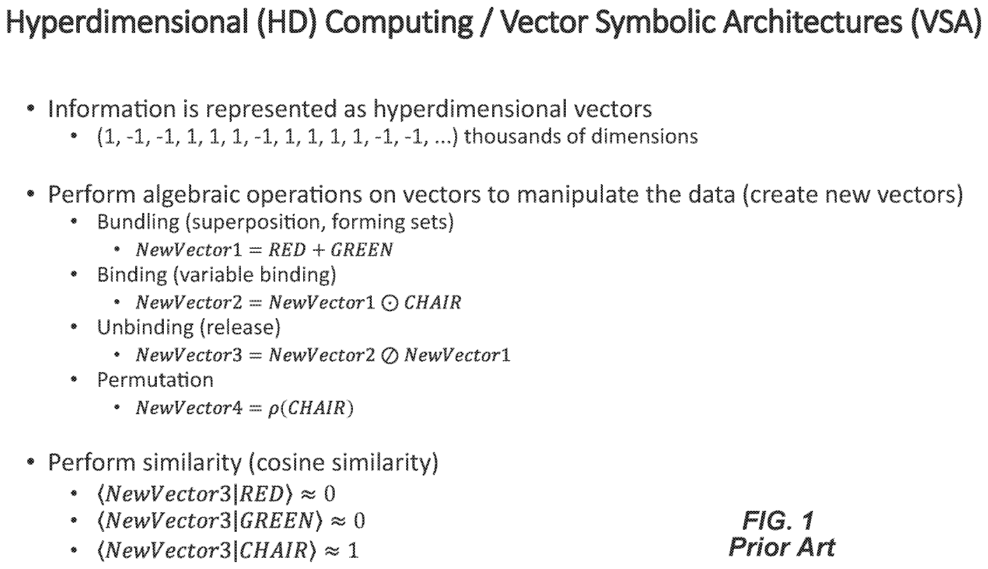

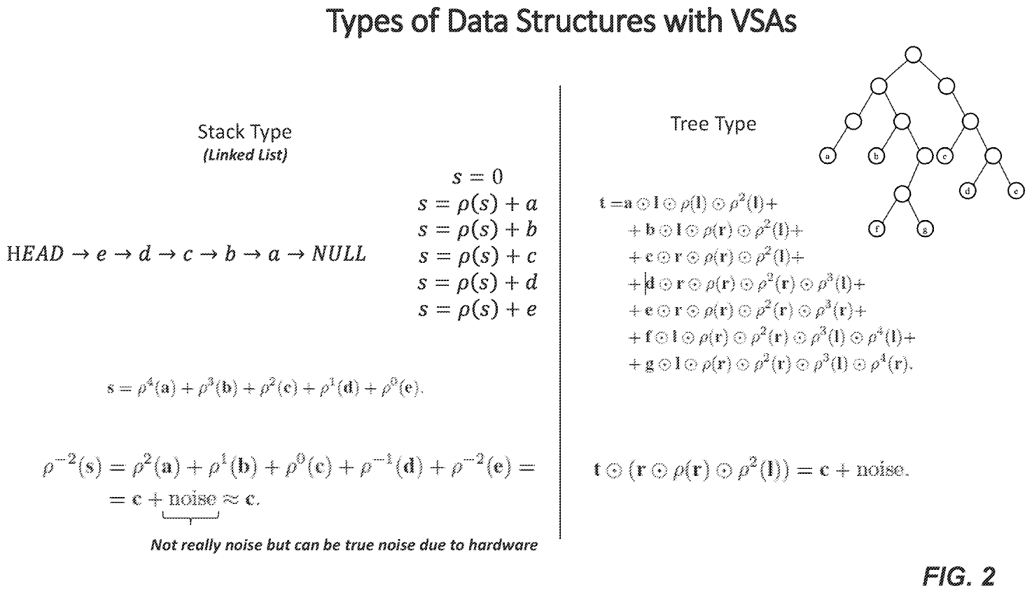

Referring to FIG. 1, in VSA, information is represented as hyperdimensional vectors having thousands of dimensions. In current methods, Algebraic operations are performed on the vectors to manipulate the data and to create new vectors by Bundling, Binding, Unbinding and Permutation. A cosine similarity is performed to measure the similarity between two vectors of an inner product space. This may be accomplished by examining the cosine of the angle between two vectors and identifying whether two vectors are pointing in roughly the same direction. Referring to FIG. 2, VSAs are capable of accommodating multiple different types of data structures, such as a Stack type data structure 500 and a Tree type data structure 502. However, “noise” may be present in the results with both the Stack type data structure and the Tree type data structure, wherein the noise may be due to the hardware. In order to determine which symbol has been identified, the result is compared to all possible symbols in the Content Addressable Memory (CAM) of the Item and the best match is selected.

Referring again to FIG. 2, consider the situation where a stacked type data structure is given by:

$$s = {ρ}^{4} ( a ) + {ρ}^{3} ( b ) + {ρ}^{2} ( c ) + {ρ}^{1} ( d ) + {ρ}^{0} ( e ) ;$$

$${ρ}^{- 2} ( s ) = {ρ}^{2} ( a ) + {ρ}^{1} ( b ) + {ρ}^{0} ( c ) + {ρ}^{- 1} ( d ) + {ρ}^{- 2} ( e ) = c + noise \approx c .$$

or perhaps the situation where a tree type data structure is given by:

$$t = a ⊙ l ⊙ ρ ( l ) ⊙ {ρ}^{2} ( l ) ++ b ⊙ l ⊙ ρ ( r ) ⊙ {ρ}^{2} ( l ) ++ c ⊙ r ⊙ ρ ( r ) ⊙ {ρ}^{2} ( l ) ++ d ⊙ r ⊙ ρ ( r ) ⊙ {ρ}^{2} ( r ) + ⊙ {ρ}^{3} ( l ) ++ e ⊙ r ⊙ ρ r ) ⊙ {ρ}^{2} ( r ) + ⊙ {ρ}^{3} ( r ) ++ f ⊙ l ⊙ ρ ( r ) {ρ}^{2} ( r ) + ⊙ {ρ}^{3} ( l ) + {ρ}^{4} ( l ) ++ g ⊙ l ⊙ ρ ( r ) ⊙ {ρ}^{2} ( r ) + ⊙ {ρ}^{3} ( l ) + {ρ}^{4} ( r ) ;$$

$$t ⊙ ( r ⊙ ρ ( r ) ⊙ ρ2 ( l ) ) = c + noise$$

In these situations, the noise may not really be noise or the noise can be true noise that may be due to hardware.

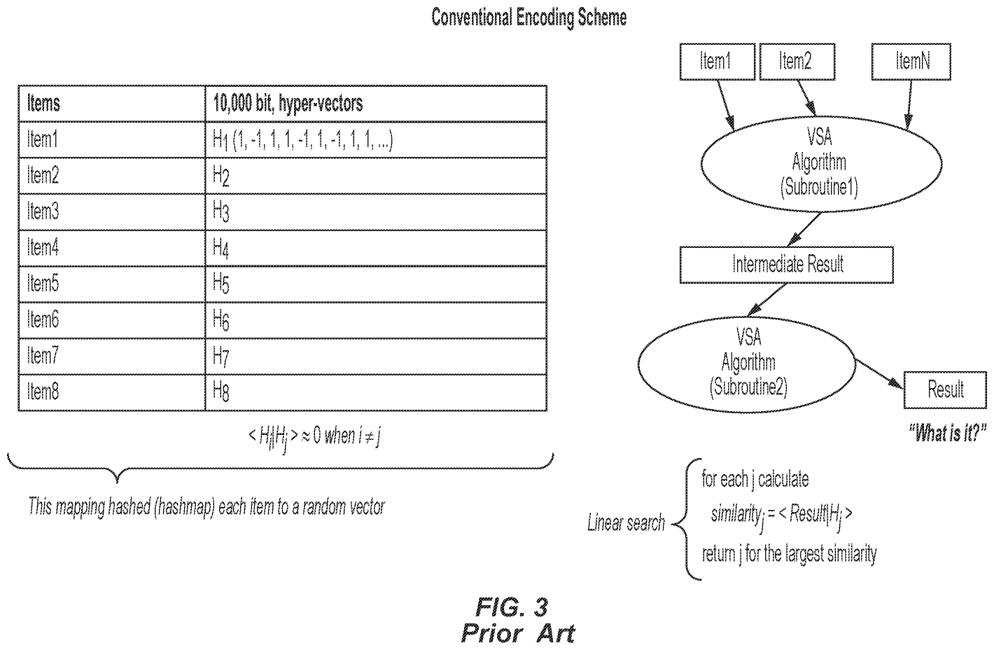

In the situations above, the symbol can be identified by comparing all possible symbols in the Item Memory (CAM) and by choosing the “best” fit symbol. Current methods for measuring large arrays of devices involve using an efficient Mat-Vec Engine Analog Crossbar Array which includes a forward cycle function for item retrieval and a Backward cycle function for CAM operation. Referring to FIG. 3, current methods typically use a conventional encoding scheme where the VSA algorithm being used implements a first sub-routine to achieve an intermediate result. The VSA algorithm then implements a second sub-routine to achieve a final result (Hⱼ). A linear search is then conducted where, for each result j, a similarity (Hⱼ) is calculated to identify the largest similarity (H), where the similarity (Hⱼ) is given by: Hⱼ=[Result/Hⱼ].

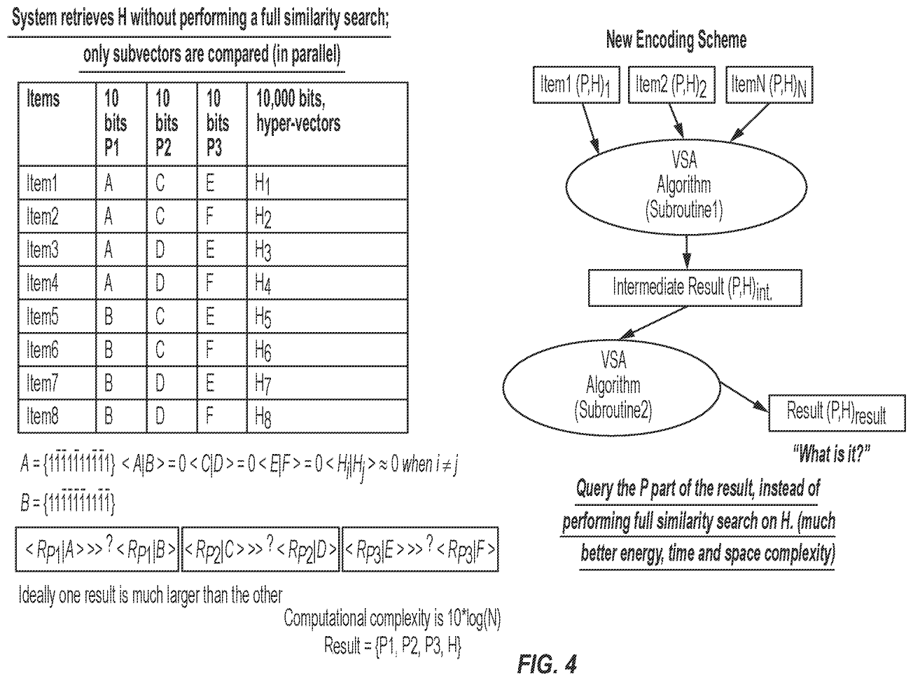

In accordance with an embodiment and referring to FIG. 4, the invention involves implementing a new encoding scheme which retrieves the similarity H without performing a full similarity search. Rather, only the sub-vectors are compared in parallel, where ideally one result will be much larger than the others. Referring again to FIG. 4, consider the situation where a data structure includes eight (8) items having four (4) sub-vectors, where each of the sub-vectors includes eight (8) items and where three (3) of the sub-vectors P each includes 10 bits. However, the fourth sub-vector H also includes eight (8) items, but includes 10,000 or more bits, so the fourth sub-vector H is a high dimensional hyper-vector. The computational complexity for determining a symbol in this situation is 10*log (N) with a result being given by Result={P1, P2, P3, H}, where P and H are high dimensional vectors, but the P vector dimension is much smaller than the H vector dimension. Moreover, the P vector and the H vector may or may not use the same encoding scheme.

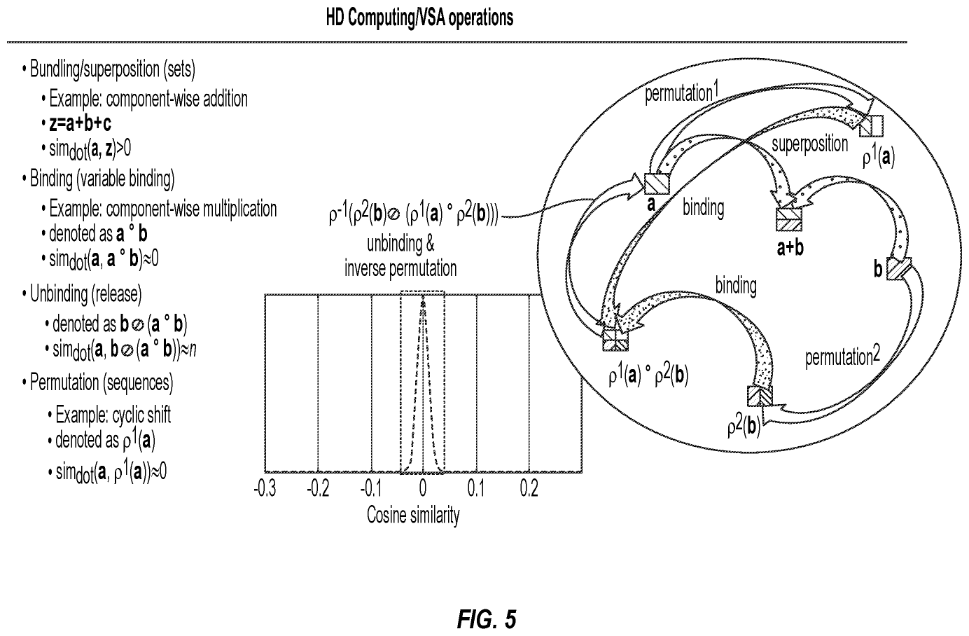

Accordingly, in an embodiment, the P vector and the H vector are processed using the same common VSA symbol similarity operations. Referring to FIG. 5, HD Computer/VSA Operation includes four operations: Bundling/superposition (sets); Binding (variable binding); Unbinding (release); and Permutation sequences. It should be appreciated that VSA operations (binding, permutation, and bundling) are used to create and compute an item memory vector for each language. The bundling/superposition (sets) operation generates a vector which relates the data from the relevant data vectors by combining all of the elements from the relevant data vectors. The binding (variable binding) operation generates a bound vector that connects the data within the bundled data vector to create role-filler pairs, to create more expressive terms and to remove as much noise as possible. The resultant bound vector may then be processed to unbind (release) the data within the resultant bound vector, thereby allowing for queries using more expressive terms without the impact of noise on the similarity search. It should be appreciated that this type of query would still work with significant amounts of fuzziness (due to noise, word ambiguities, etc).

In an embodiment, the invention allows for the VSA symbol similarity operations to be split for the P vectors and the H vectors. Accordingly, the VSA symbol similarity operations for the P vectors may be performed on one set of hardware components and the VSA symbol similarity operations for the H vectors may be performed on a different set of hardware components. Moreover, in an embodiment only the P vector parts of the symbol similarity operations result may be queried, rather than performing a full similarity search on the H vector parts of the symbol similarity operations result.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

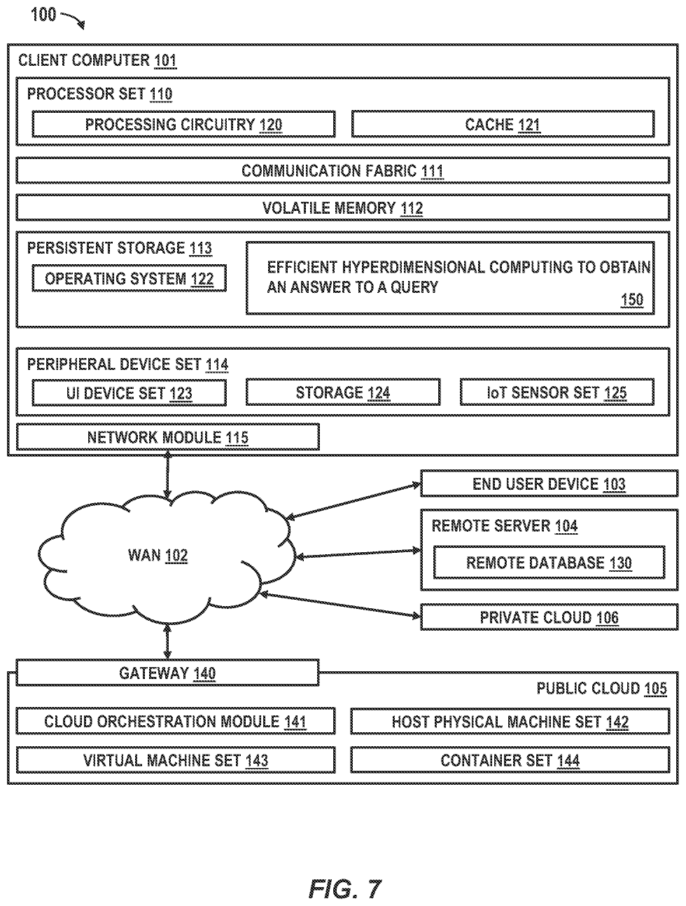

Referring to FIG. 7, computing environment 100 contains an example of an environment for the execution of at least some of the computer code involved in performing the inventive methods, such as for hyperdimensional computing to obtain an answer to a query 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 7. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform tasks. More specifically, one or more embodiments described herein can incorporate and utilize rule-based decision making and artificial intelligence (AI) reasoning to accomplish the various operations described herein, namely containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

It should be appreciated that HD computing/VSA operations are useful for solve for problems which include vectors having arbitrarily large dimensionality D≥10,000. The use of large vectors to resolve problems allows for a distributed representation approach where the identify of a symbol may be encoded across all components of the vector, where each component of the vector “takes part” in representing the desired symbol. Moreover, HD computing/VSA do not rely on backpropagation. Accordingly, a pattern may be identified via a single example.

In an embodiment, the method of the invention allows for hyperdimensional computing of a large number N of items (item1, item2, . . . itemN). The method includes encoding the N items with high dimensional vectors P, H, where the P vector component is much smaller than the H vector component. The encoded high dimensional vectors P, H are then processed using a first sub-routine of VSA operations (item1(P,H)₁, item2(P,H)₂, . . . itemN(P,H)_{N}) to generate an intermediate result (P,H)ᵢₙₜ having P vector components and H vector components. It should be appreciated that the first sub-routine of VSA operations includes performing a bundling/superposition operation and a binding operation on the encoded high dimensional vectors P, H. A second sub-routine of VSA operations is then performed on the intermediate result (P,H)ᵢₙₜ to obtain a result (P,H)ᵣₑₛᵤₗₜ. It should be appreciated that the second sub-routine of VSA operations includes performing an unbinding operation on the intermediate result (P,H)ᵢₙₜ to generate an N number of unbound data points within the P vector component and the H vector component and performing a permutation operation on the unbound intermediate result (P,H)ᵢₙₜ to generate the final result (P,H)ᵣₑₛᵤₗₜ having an N number of permutated data points within the P vector component and the H vector component. A similarity search is performed on the final result (P,H)ᵣₑₛᵤₗₜ, wherein the similarity search only queries the P vector components of the (P,H)ᵣₑₛᵤₗₜ and not the H vector components of the (P,H)ᵣₑₛᵤₗₜ.

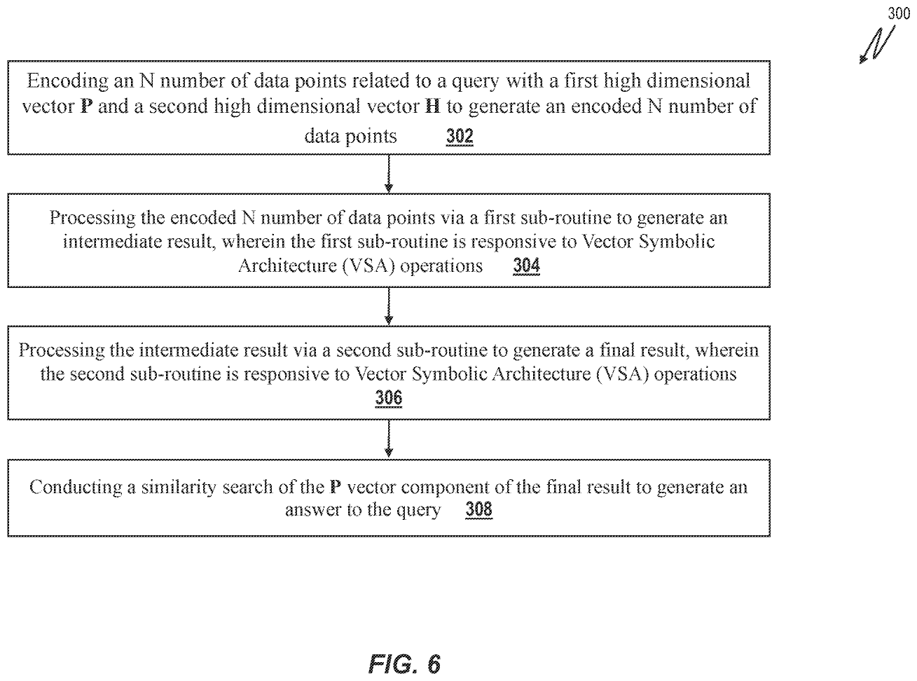

In accordance with an embodiment, a method 300 for Hyperdimensional (HD) computing is provided, as shown in FIG. 6. The method 300 includes encoding each of N number of data point with a first high dimensional vector P and a second high dimensional vector H, wherein the first high dimensional vector P is much smaller than the second high dimensional vector H, as shown in operational block 302. It should be appreciated that the N number of data points may be data points that describe or represent elements that are required to answer a question. For example, consider the question “What is the dollar of Mexico”? The N number of data points that may be used to answer that question, such as the name of this country (USA), the capital of this country (Washington D.C.), the monetary unit of the USA (dollar), the country on the southern border of the USA (Mexico), the capital of Mexico (Mexico City) and the currency of Mexico (Peso) may be included in the N number of data points.

The method 300 includes processing the encoded N number of data points via a first sub-routine of VSA operations to obtain an intermediate result (P,H)ᵢₙₜ, as shown in operational block 304. This may be accomplished by performing a bundling/superposition operation to generate an N number of bundled data points within the P vector component and the H vector component which are bundled together. Additionally, a binding operation is preformed on the encoded first and second high dimensional vectors P, H (i.e., the N number of bundled data points) to generate the intermediate result (P,H)ᵢₙₜ having an N number of bound data points within the P vector component and the H vector component. The method includes processing the intermediate result (P,H)ᵢₙₜ via a second sub-routine of VSA operations to obtain a result (P,H)ᵣₑₛᵤₗₜ, as shown in operational block 306. The method further includes conducting a similarity search of the P vector components of the result (P,H)ᵣₑₛᵤₗₜ to identify the desired result, as shown in operational block 308.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein. Moreover, the embodiments or parts of the embodiments may be combined in whole or in part without departing from the scope of the invention.

1. A method for hyperdimensional computing to obtain an answer to a query, the method comprising:
encoding each of an N number of data points related to the query with a first high dimensional vector P and a second high dimensional vector H to generate an encoded N number of data points having a P vector component and an H vector component;
processing the encoded N number of data points via a first sub-routine to generate an intermediate result, wherein the first sub-routine is responsive to Vector Symbolic Architecture (VSA) operations;
processing the intermediate result via a second sub-routine to generate a final result, the second sub-routine including a linear search where, for each result j, a similarity (Hⱼ) is calculated, and a largest similarity (Hⱼ) is identified, where the similarity (Hⱼ) is given by: Hⱼ=[Result/Hⱼ], and wherein the second sub-routine is responsive to Vector Symbolic Architecture (VSA) operations; and
conducting a similarity search of the P vector component of the final result to generate an answer to the query, wherein the similarity search of the P vector retrieves the similarity H without performing a full similarity search.

2. The method of claim 1, wherein the N number of data points are selected responsive to the query.

3. The method of claim 1, wherein the H vector component is larger than the P vector component.

4. The method of claim 1, wherein the first sub-routine includes performing a bundling/superposition operation on the P vector component and the H vector component to generate an N number of bundled data points within the P vector component and the H vector component which are bundled together.

5. The method of claim 4, wherein the first sub-routine further includes performing a binding operation on the N number of bundled data points to generate the intermediate result having an N number of bound data points within the P vector component and the H vector component.

6. The method of claim 1, wherein the second sub-routine includes performing a unbinding operation on the N number of bound data points to generate an N number of unbound data points within the P vector component and the H vector component.

7. The method of claim 6, wherein the second sub-routine further includes performing a permutation operation on the N number of unbound data points to generate the final result having an N number of permutated data points within the P vector component and the H vector component.

8. A non-transitory computer readable medium storing instructions configured to cause a computer system to implement operations comprising:
encoding each of an N number of data points related to the query with a first high dimensional vector P and a second high dimensional vector H to generate an encoded N number of data points having a P vector component and an H vector component;
processing the encoded N number of data points via a first sub-routine to generate an intermediate result, wherein the first sub-routine is responsive to Vector Symbolic Architecture (VSA) operations;
processing the intermediate result via a second sub-routine to generate a final result, wherein the second sub-routine is responsive to Vector Symbolic Architecture (VSA) operations, the second sub-routine including a linear search where, for each result j, a similarity (Hⱼ) is calculated, and a largest similarity (Hⱼ) is identified, where the similarity (Hi) is given by: Hⱼ=[Result/Hⱼ]; and
conducting a similarity search of the P vector component of the final result to generate an answer to the query, wherein the similarity search of the P vector retrieves the similarity H without performing a full similarity search.

9. The non-transitory computer readable medium of claim 8, wherein the N number of data points are selected responsive to the query.

10. The non-transitory computer readable medium of claim 8, wherein the H vector component is larger than the P vector component.

11. The non-transitory computer readable medium of claim 8, wherein the first sub-routine includes performing a bundling/superposition operation on the P vector component and the H vector component to generate an N number of bundled data points within the P vector component and the H vector component which are bundled together.

12. The non-transitory computer readable medium of claim 11, wherein the first sub-routine further includes performing a binding operation on the N number of bundled data points to generate the intermediate result having an N number of bound data points within the P vector component and the H vector component.

13. The non-transitory computer readable medium of claim 8, wherein the second sub-routine includes performing a unbinding operation on the N number of bound data points to generate an N number of unbound data points within the P vector component and the H vector component.

14. The non-transitory computer readable medium of claim 13, wherein the second sub-routine further includes performing a permutation operation on the N number of unbound data points to generate the final result having an N number of permutated data points within the P vector component and the H vector component.

15. A computer program product comprising a non-transitory computer readable storage medium having program instructions embodied therewith, the program instructions executable by a processor to cause the processor to perform operations for implementing a method for hyperdimensional computing to obtain an answer to a query, the method comprising:
encoding each of an N number of data points related to the query with a first high dimensional vector P and a second high dimensional vector H to generate an encoded N number of data points having a P vector component and an H vector component;
processing the encoded N number of data points via a first sub-routine to generate an intermediate result, wherein the first sub-routine is responsive to Vector Symbolic Architecture (VSA) operations;
processing the intermediate result via a second sub-routine to generate a final result, wherein the second sub-routine is responsive to Vector Symbolic Architecture (VSA) operations, the second sub-routine including a linear search where, for each result j, a similarity (Hⱼ) is calculated, and a largest similarity (Hⱼ) is identified, where the similarity (Hⱼ) is given by: Hⱼ=[Result/Hⱼ]; and
conducting a similarity search of the P vector component of the final result to generate an answer to the query, wherein the similarity search of the P vector retrieves the similarity H without performing a full similarity search.

16. The computer program product of claim 15, wherein
the N number of data points are selected responsive to the query, and
the H vector component is larger than the P vector component.

17. The computer program product of claim 15, wherein the first sub-routine includes performing a bundling/superposition operation on the P vector component and the H vector component to generate an N number of bundled data points within the P vector component and the H vector component which are bundled together.

18. The computer program product of claim 17, wherein the first sub-routine further includes performing a binding operation on the N number of bundled data points to generate the intermediate result having an N number of bound data points within the P vector component and the H vector component.

19. The computer program product of claim 15, wherein the second sub-routine includes performing a unbinding operation on the N number of bound data points to generate an N number of unbound data points within the P vector component and the H vector component.

20. The computer program product of claim 19, wherein the second sub-routine further includes performing a permutation operation on the N number of unbound data points to generate the final result having an N number of permutated data points within the P vector component and the H vector component.
